(19) United States
(12) Patent Application Publication
(10) Pub. No.: US 2022/0343262 A1
(43) Pub. Date: Oct. 27, 2022

(54) SYSTEM FOR PROVIDING SUPPLY CHAIN INFORMATION

(71) Applicant: PAPERTALE TECHNOLOGIES AB, Malmö (SE)

(72) Inventor: Bilal Tufail BHATTI, Malmö (SE)

(73) Assignee: PAPERTALE TECHNOLOGIES AB, Malmö (SE)

(21) Appl. No.: 17/763,006

(22) PCT Filed: Sep. 28, 2020
(86) PCT No.: PCT/SE2020/050909

§ 371 Date: Mar. 23, 2022

(30) Foreign Application Priority Data
Sep. 27, 2019 (SE) 1951097-3

(51) Int. Cl. G06Q 10/08; G06Q 30/00

(52) U.S. Cl. CPC G06Q 10/08; G06Q 30/018

(57) ABSTRACT

A computer-implemented system for providing supply chain information of one or more products is provided herein. The system includes a distributed ledger configured to manage supply chain information of the one or more products. The system further includes a processing unit configured to retrieve said supply chain information from the distributed ledger and process said retrieved supply chain information. Further, the system includes at least one consumer device configured to retrieve said processed supply chain information and to cause at least one change to the distributed ledger.

### CROSS REFERENCE TO RELATED APPLICATIONS

The instant application is a U.S. National Stage application of and claims priority to PCT/SE2020/050909, filed on Sep. 28, 2020, which is a PCT application of and claims priority to SE Application No. 1951097-3, filed on Sep. 27, 2019, the subject matter of both aforementioned applications are hereby incorporated by reference in their entireties.

### TECHNOLOGY FIELD

The present invention relates to the technical field of supply chains. More specifically, the present invention relates to a system for providing product supply chain information.

### BACKGROUND

There is a growing demand of transparency in today's digital world. Consumers are becoming increasingly aware of the exploitations and fake claims in the supply chains of consumer products. In particular, fashion which is the second biggest polluter industry on earth after petroleum, fake claims are an alarming problem. Governments and consumers are pushing fashion industry to control their supply chains and make slavery free clothes and less damaging to the environment. By 2018, 7 out of G20 countries have passed anti-slavery laws which forces them to document and declare the steps taken in their supply chains to avoid slavery. 1 out of 5 people in the world are connected to the fashion supply chain. This makes it one of the most labor-intensive industries in the world. With the advent of internet buying, this industry has caused to develop more complex supply chains than ever. This has given rise to more exploitation and abuse of workers' rights.

The global sustainability drive has not been able to offer more than some nice pictures of the few good factories in their supply chains and claiming transparency. In the name of sustainability, many different certification methods have risen during the last decade or so, but the problem is that in general it is both easier and a lot cheaper for the factories to simply bribe the inspector and thus receive the certificate, than it is to actually implement the procedures and processes which is needed to receive the certificate. As a result, modern consumers who are more aware than the past generations do not trust most of the brands sustainability and transparency claims.

The present inventors have identified problems and shortcomings with providing the consumers with the information they need. Consumers don't want to know the laws or the methods of how the brands are using sustainability, they want a clean conscience and want to know if the product they are using is free of child labor and is not made by slaves. Additionally, they consumers also want to know whether the product has any big damaging impact on the environment.

Accordingly, an object of the present invention is to overcome these problems.

### SUMMARY

An object of the present disclosure is to provide a system, device, product, methods and computer program products which seeks to mitigate, alleviate, or eliminate one or more of the above-identified deficiencies in the art and disadvantages singly or in any combination.

In a first aspect, a computer-implemented system for providing supply chain information of one or more products is provided. The system comprises a distributed ledger configured to manage supply chain information of the one or more products; a processing unit configured to retrieve said supply chain information from the distributed ledger and process said retrieved supply chain information; and at least one consumer device configured to retrieve said processed supply chain information and to cause at least one change to the distributed ledger.

The computer-implemented system according to the first aspect is a hybrid of modern shopping experience (i.e. based on conscious consumerism) & cooperative society where consumers are able to directly fund the social causes primarily aimed at education. The system offers direct traceability to the consumer of all the people behind that specific product, the people being designers, technicians and workers.

The technology behind the system is making sure that the garment you are wearing is free from slavery, child labor and that the workers are being paid fairly, being a part of the social security system and having the security of employment contracts. The technology further makes sure that salaries are paid as per law of the country. This ensures that nobody has to work under the minimum wage at least.

The system further enables a gift based system to help consumers directly contribute financially to the people involved behind that particular product. The financial gift can be directly traced to the concerned person's wallet because it's in the shape of ERC20 token i.e. crypto-currency. The purpose of the financial gift is to give encouragement of good work. Additionally, due to the money transparency of the invention, consumers can see the money trail of their financial gift. Consumers can go even further and help people get out of their poverty lines by supporting social causes mainly focused on education. The system also enables consumers to track the journey of the end product in the supply chain i.e. garment in current scenario. Hence, the system according to the first aspect is sanctioned by the workers and the environment itself

The distributed ledger of the system uses distributed ledger technology to ensure trustworthiness of its claims. It will keep answering sustainability questions like “If my salary is paid as per law” or “If I worked in a safe environment”. Viewing transaction history of the donations to an e.g. school eliminates the risk of corruption which exists in most other charities, since the use of their received donations can never be verified.

As a consumer, power to change the lives of the creators of our garments is given, by simply adding a small contribution to enable future self-reliant assets to the whole society. The system will hence give consumers the power to impact millions of lives for the better by offering complete transparency to the consumer. The invention lets you meet the workers behind the garment, be assured of their wellbeing, educate their kids and get a real-time environmental footprint.

In one embodiment, the at least one consumer device is configured to retrieve said processed supply chain information by scanning a readable tag associated with the one or more products.

in one embodiment, the at least one consumer device comprises a consumer interface configured to visualize supply chain information relating to the one or more products.

In one embodiment, the consumer interface may be further configured to visualize data legitimacy of the supply chain information of the one or more products, and/or sustainability efforts of the companies or brands behind the one or more products.

In one embodiment, the at least one consumer device is configured to receive one or more consumer actions through the consumer interface, the one or more consumer actions being indicative of at least one change to the distributed ledger.

In one embodiment, the one or more consumer actions may represent a purchase of a product; an environmental compensation of a product; a support to social causes; and/or a donation of a gift.

In one embodiment, the system further comprises at least one supplier device comprising a supplier interface configured to visualize supply chain information relating to the one or more products.

In one embodiment, the at least one supplier device may be configured to receive one or more supplier actions through the supplier interface, the one or more supplier actions being indicative of at least one change to the distributed ledger.

In one embodiment, the one or more supplier actions may represent a gathering of materials relating to the one or more products; a processing of materials relating to the one or more products; a production of one or more products; and/or a retrieval of a donation.

In one embodiment, the distributed ledger is configured to manage supply chain information of the one or more products by causing changes to itself in response to receiving actions being indicative of changes to the distributed ledger; the one or more products being transported; and/or a predetermined time period having passed.

In one embodiment, the processing unit is configured to retrieve supply chain information from the distributed ledger by monitoring a supply chain of a particular product among the one or more products.

In one embodiment, the processing unit is configured to process said retrieved supply chain information by: for every change in the distributed ledger of the supply chain of the particular product, calculating an environmental footprint of the particular product, and accumulating a total environmental footprint of the particular product.

In one embodiment, the processing unit is further configured to process said retrieved supply chain information by verifying data legitimacy of the supply chain of the particular product.

In one embodiment, the processing unit is further configured process said retrieved supply chain information by calculating and verifying sustainability efforts of the companies or brands behind the one or more products.

In one embodiment, the one or more products is a garment and supply chain information thereof involves organizations, people, activities or resources involved in supplying said garment.

In a second aspect, a consumer device is configured to perform the functionality of the at least one consumer device according to the first aspect and any of the preceding embodiments.

In a third aspect, a product associated with a readable tag, the readable tag being configured to be scanned by a consumer device according to the second aspect.

In a fourth aspect, a computer-implemented method for operating a consumer device to allow its user to provide supply chain information relating to one or more products is provided. The method comprises: retrieving processed supply chain information by scanning a readable tag associated with the one or more products; receiving consumer actions being indicative of changes to backend server functionality; and causing changes to said backend server functionality.

In a fifth aspect, a computer-implemented method for providing supply chain information relating to one or more products is provided. The method comprises: managing supply chain information relating to the one or more products in a distributed ledger; causing changes to the distributed ledger in response to: receiving consumer actions from at least one consumer device, receiving supplier actions from at least one supplier device, transporting of the one or more products, or passing of a predetermined time period; and processing supply chain information of the distributed ledger.

In a sixth aspect, a computer program product is provided. The computer program product comprises computer code for performing the method according to the fourth aspect when the computer program code is executed by a processing device.

In a seventh aspect, a computer program product is provided. The computer program product comprises computer code for performing the method according to the fifth aspect when the computer program code is executed by a processing device.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a block diagram illustrating some components according to one embodiment of the invention.

FIG. 2 is an exemplary illustration of one embodiment of the invention.

FIGS. 3a-q are flowcharts illustrating the flow of data and the associated feedback actions and entities in the system according to different embodiments.

FIGS. 4a-c are views of different embodiments of consumer interfaces.

FIG. 5 is a view of one embodiment of a supplier interface.

FIG. 6 illustrates a block diagram of a method according to one embodiment.

FIG. 7 illustrates a block diagram of a method according to one embodiment.

### DETAILED DESCRIPTION OF THE EMBODIMENTS

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

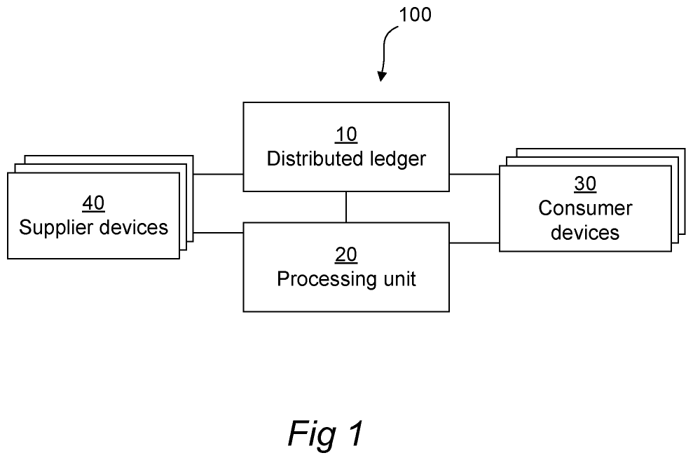

With reference to FIG. 1, one embodiment is shown of a computer-implemented system 100 with associated components. In different settings, implementations or embodiments, the computer-implemented system 100 may comprise fewer or any additional components than those illustrated in FIG. 1. As can be seen in FIG. 1, the system 100 comprises a distributed ledger 10, a processing unit 20, one or more consumer devices 30, and one or more supplier devices 40.

In different embodiments of the invention, the components of the computerized system 100 may be implemented using instructions that enable hardware functionality, for example, by using computer program instructions executable in a general-purpose or special-purpose processor. The instructions may be stored on a computer-readable storage medium (disk, memory, etc.) to be executed by such a processor. The components are configured to read instructions from one or more computer memories and execute these instructions to control the operation of the computer-implemented system 100. The computer memories may be implemented in any known memory technology, including but not limited to ROM, RAM, SRAM, DRAM, CMOS, FLASH, DDR, SDRAM, or some other memory technology. In some embodiments, the memories may be integrated with or be internal to the specific components of the computer-implemented system 100.

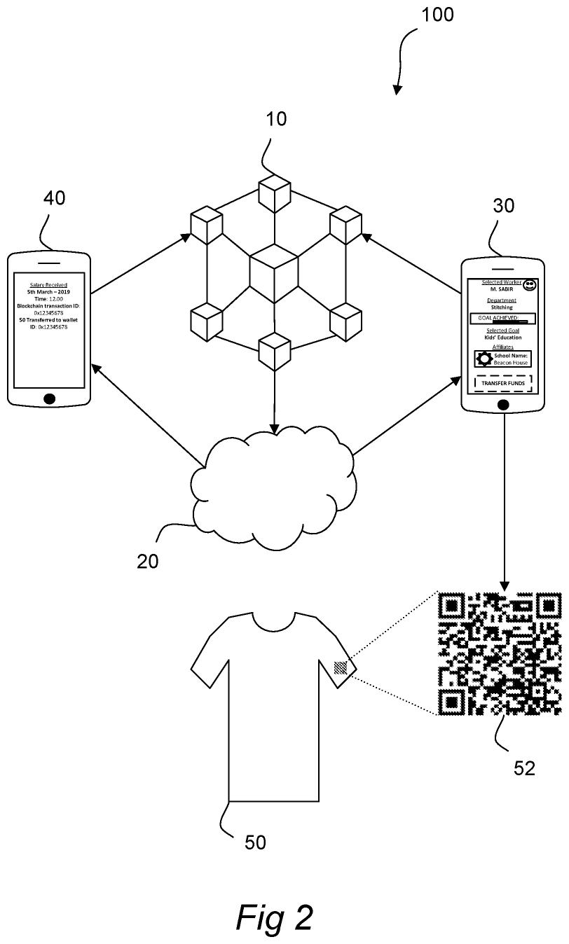

A computer-implemented system 100 as disclosed herein is typically used for supply chain management. The skilled person may also realize other fields of technical application. In settings of supply chain management, transparency is much sought-after. Such transparency involves providing trustworthiness and reliability for all users, manufacturers, companies, brands or organizations, etc., that are in some sense related to the system 100. Consequently, one major advantage of the computer-implemented system 100 is therefore the possibility for users to set up customized profiles depending on interests and roles. For instance, brands and/or companies may set up specific company or brand profiles with e.g. environmental goals. Such company or brand profiles is advantageous in order to gain credibility and trust from consumers by “showing their numbers”, i.e. by presenting a company's or brand's environmental impact. This is especially true for companies or brands that sell products 50 (as illustrated in FIG. 2). Moreover, a protection against laws relating to anti-slavery, minimum wages, and so on can be assured by selling such products.

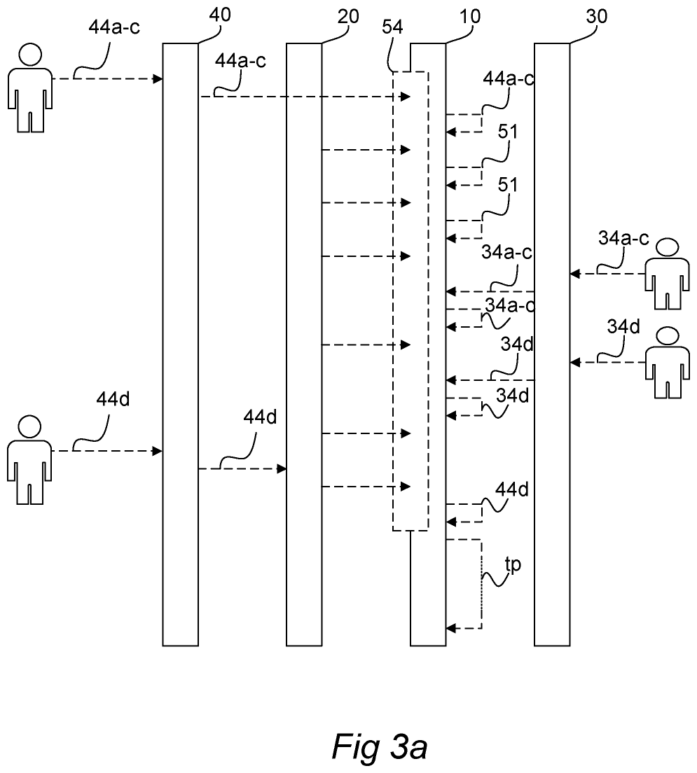

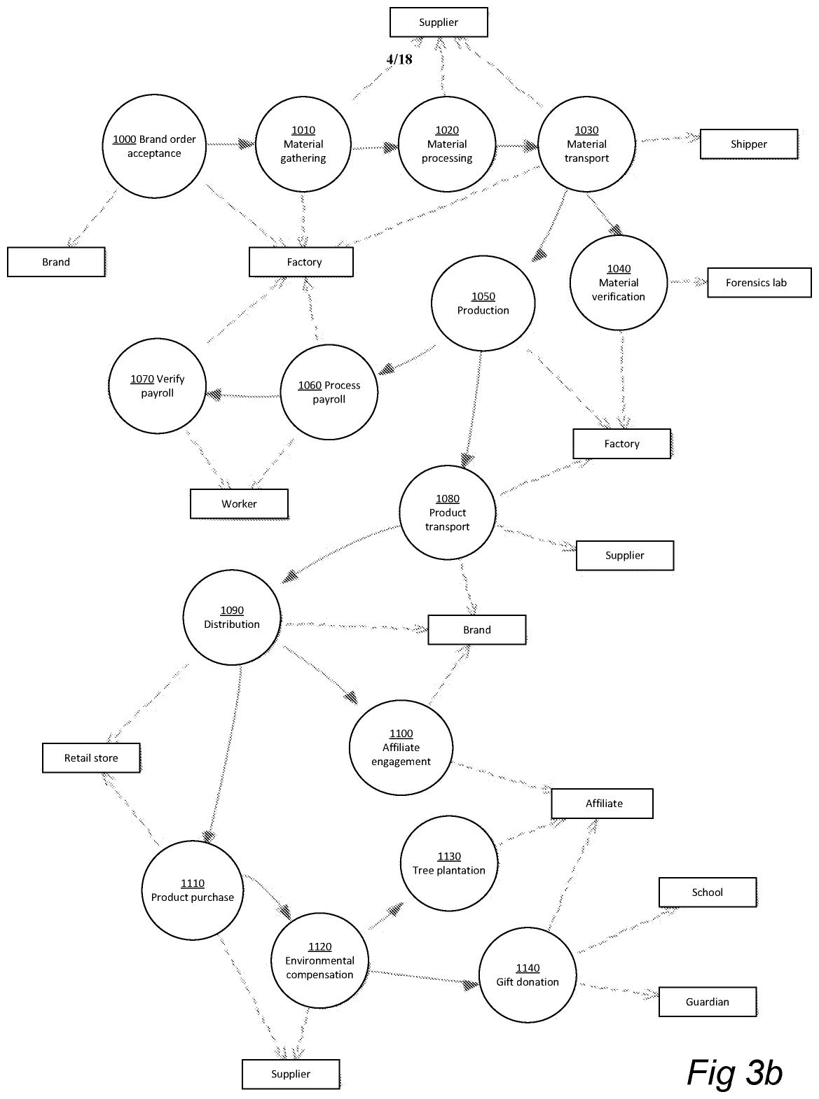

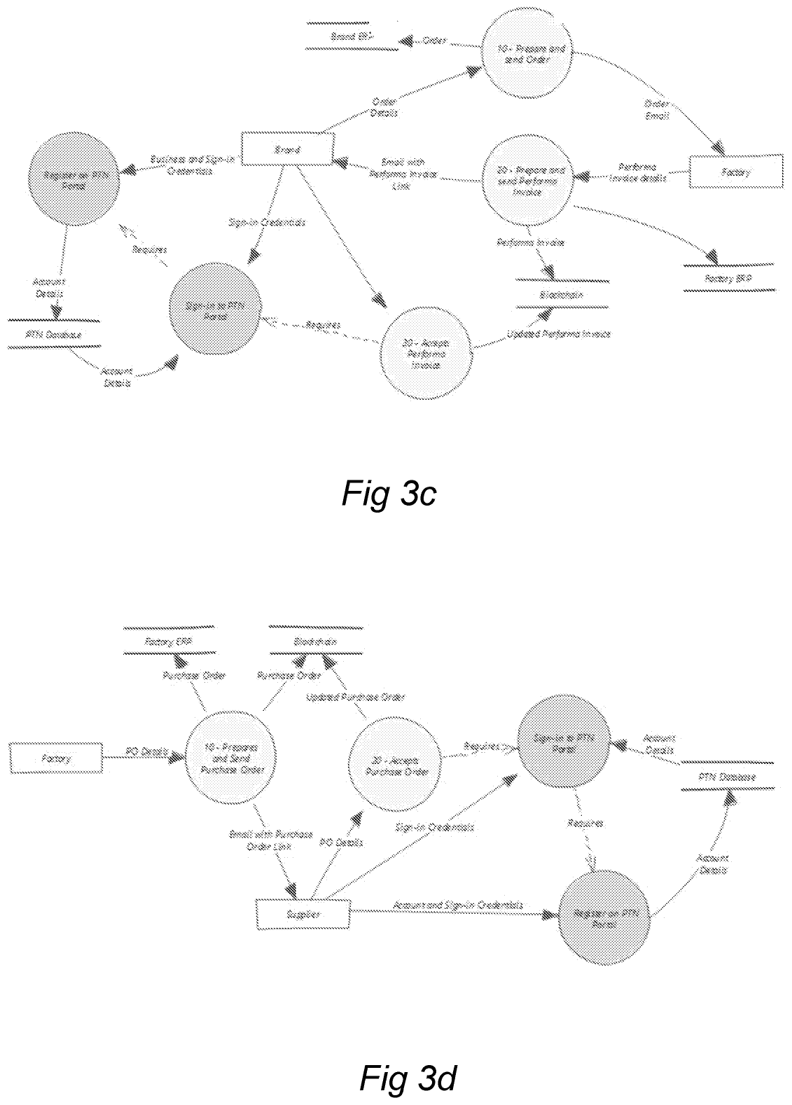

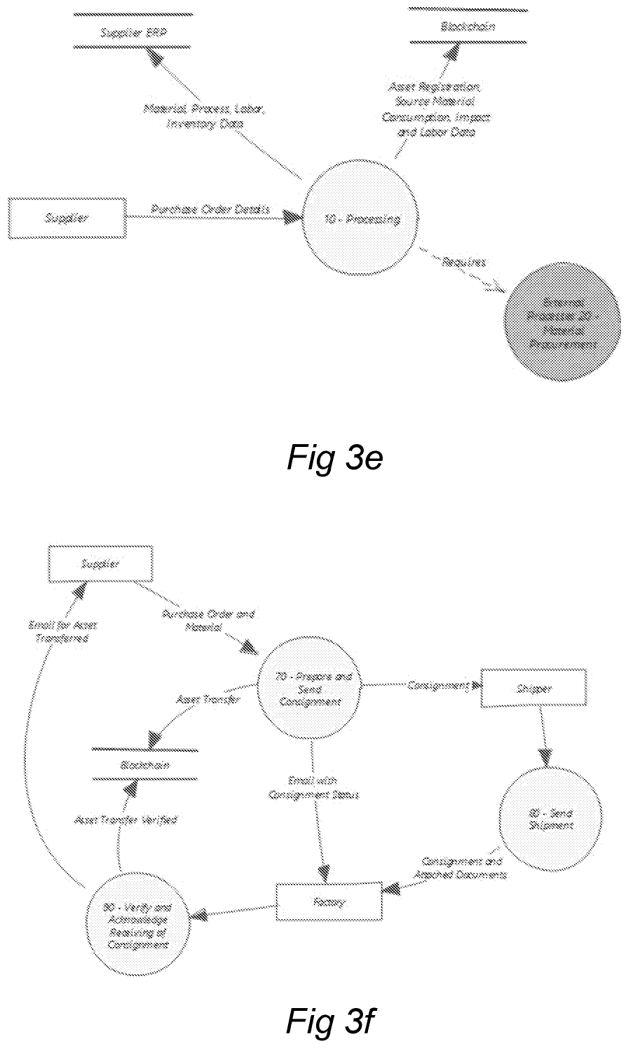

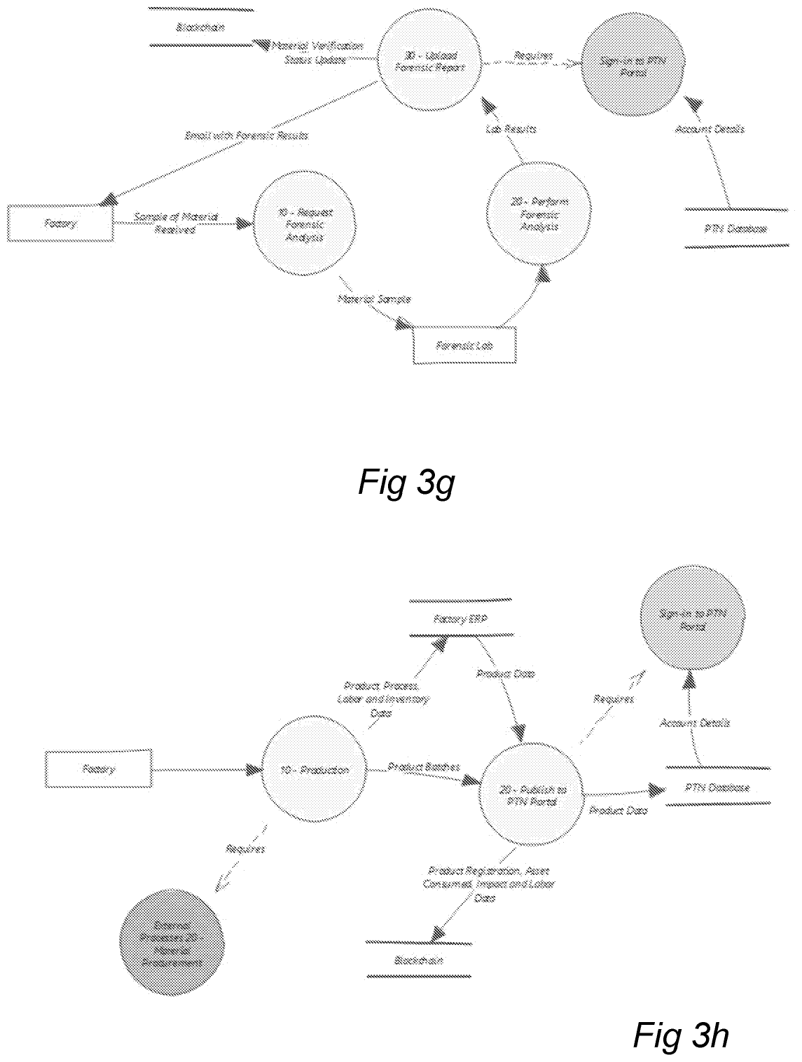

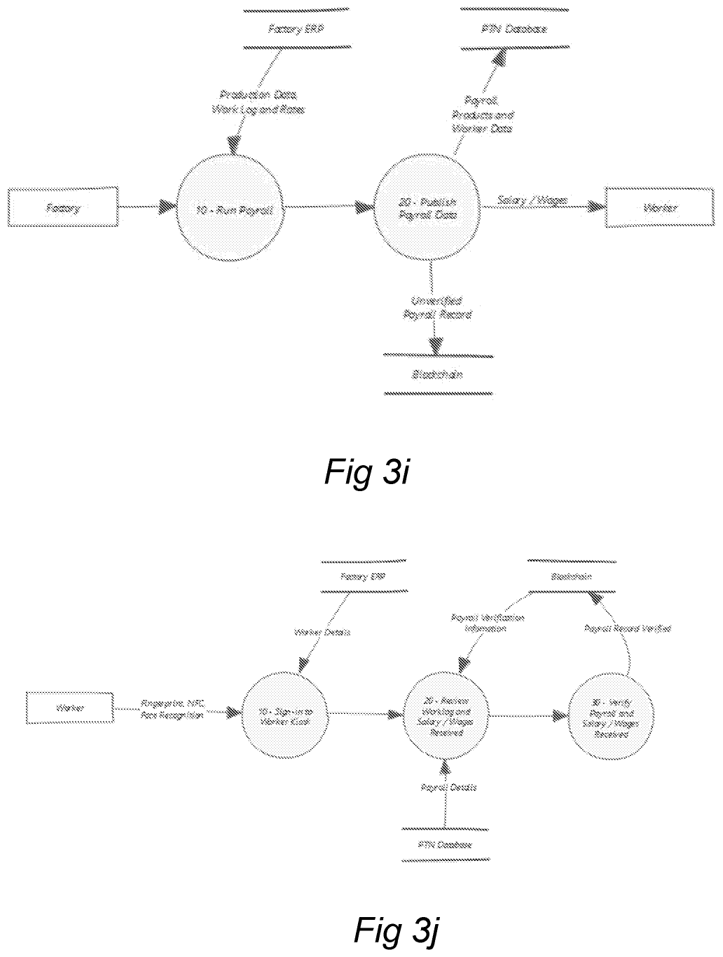

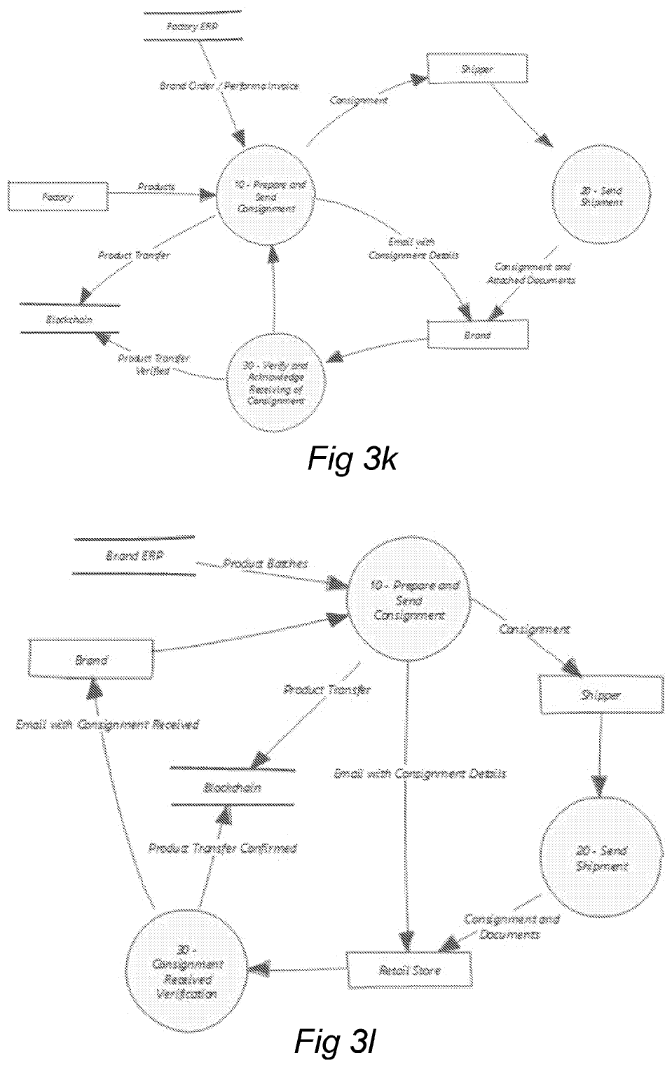

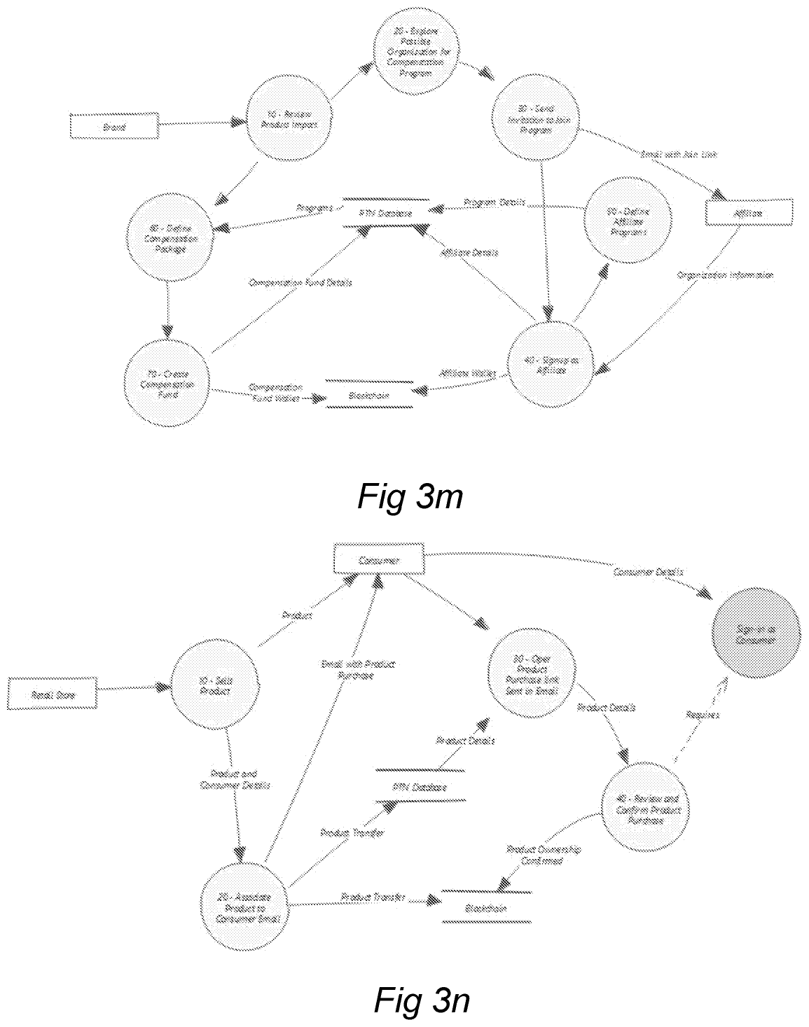

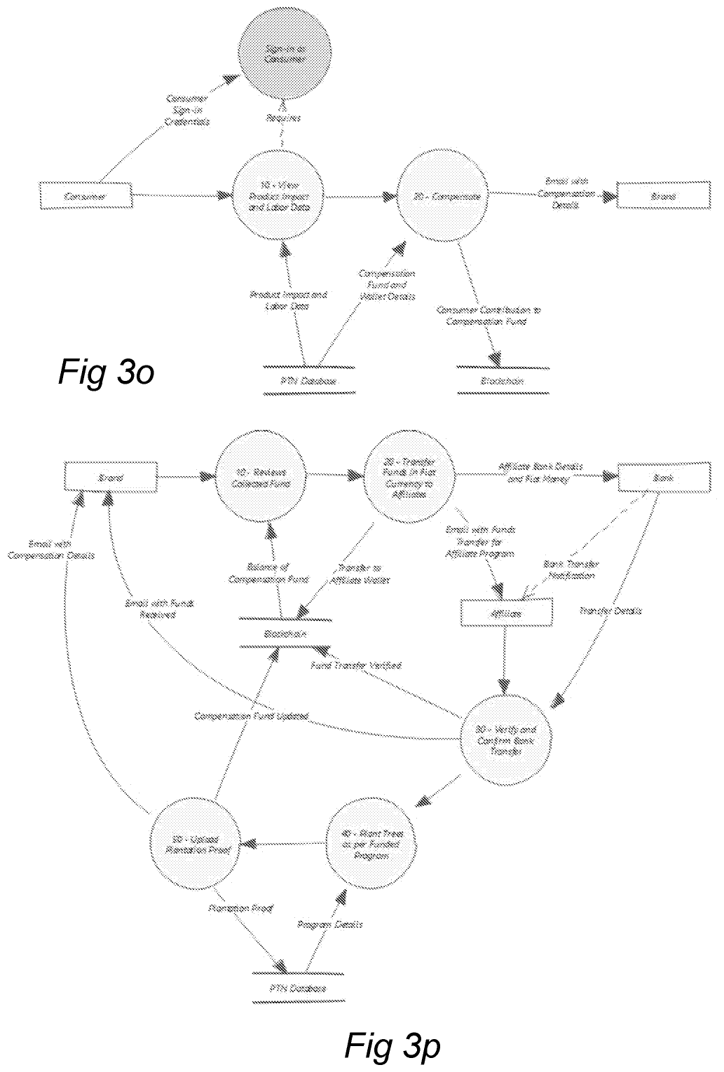

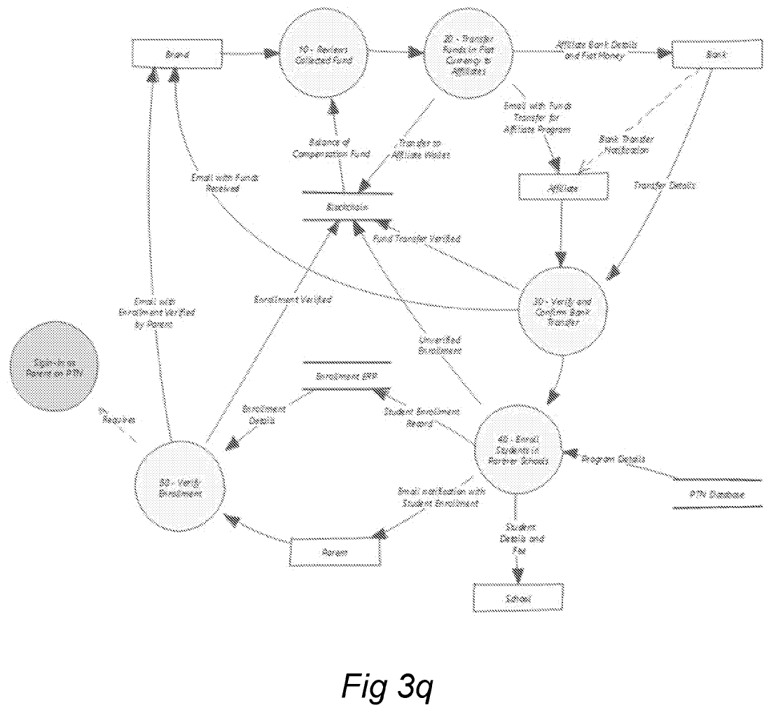

Moreover, normal consumers wishing to buy products 50 may set up consumer profiles with personal interests, product requirements, and goals. Such profiles may contain an ethical score, being accumulated for every choice the user has done in relation to donations, compensations, purchases, and so forth. The ethical score is preferably calculated in the processing unit 20, and retrieved by the consumer device 30 wishing to view the score in an interface associated with the device 30. The ethical score may be shared with other consumer and/or worker devices 30, 40 being associated with the computer-implemented system 100. Finally, suppliers, manufacturers or workers may set up their own profiles and assigning specific personal goals related to e.g. retrieving of gifts to pay for kids' education. The worker profile may involve verified information such as gender, age, minimum wage, etc. All this information is verified using e.g. smart contracts in the distributed ledger 10. This will be discussed more with reference to FIGS. 3a-c and 4. An important component for providing such transparency is the technical provisions of having a (digital) distributed ledger 10 interconnected with other parts of the system 100, as shown in FIG. 1.

With reference to FIG. 2, the illustration shows a computer-implemented system 100 according to one embodiment. In the shown embodiment, the computer-implemented system 100 comprises a distributed ledger 10 implemented using public blockchain technology and a processing unit 20 implemented as a cloud-computing service. The system 100 further comprises one supplier device 40 and one consumer device 30 illustrated as mobile phones. The system 100 may in other embodiments or configurations comprise a plurality of consumer devices 30 and/or supplier devices 40. The skilled person realizes that the at least one consumer device 30 and/or supplier device 30 may further be connected to other networks, servers, devices, and so forth, not necessarily being a part of the computer-implemented system 100 as shown in FIG. 2.

In the embodiment shown in FIG. 2, the product 50 is a garment. More especially, the product is a shirt. In other embodiments the product 50 may also be related to pharmaceuticals, food, furniture, toys, electronics, and other reasonable areas as conceived by the person skilled in the arts of supply chain management. For a product of any kind, the supply chain information thereof involves organizations, people, activities or resources involved in manufacturing said product.

The product is preferably arranged with a readable tag 52. A readable tag may be a physical tag or a digital or virtual illustration of a tag. The tag 52 may be arranged on the product or on a package or container of the product. The package or container of the product may also be seen as the product or as a part of the product. The tag is preferably configured to be scanned. For this, it is preferred if the tag is a digitally readable tag. The readable tag 52 may be based on any known scanning technology, such as NFC, RFID or QR, wherein the consumer device 30 functions as a scanner for the technology used by the particular tag 52. In the illustrated embodiment of FIG. 2, the readable tag 52 is based on QR-technology. It is however just an illustration, as in preferred embodiments of the invention, the readable tag 52 is based on NFC-technology.

In preferred embodiments of the invention, the readable tag 52 is extremely durable, so that it can withstand extensive laundry conditions, transport and general tear and wear. The tag 52 may for instance comprise plastic materials such as ABS, polycarbonate, PPSU or UHMW.

In one embodiment, the contents of the readable tag 52 may be encrypted, so that counterfeiting of the products may be prevented. Such encrypted tags 52 may be based on any known encryption technology in the art.

In one embodiment, the tag 52 is arranged inside the product 50, by for instance weaving it into the fabric of the garment, so that it may be protected from collisions or tear and wear. Importantly, the tag 52 is however still readable by the consumer and/or supplier device 30, 40, even if it's weaved into the fabric.

In one embodiment, if a user of the consumer device 30 wishes to retrieve supply chain information of a product 50, he/she can scan the readable tag 52 associated with the product. The consumer device 30 may be configured to scan the readable tag 52 associated with the product 50. The readable tag 52 is associated with the product 50 in the sense that it redirects the user of the consumer device 30 scanning the tag 52 to a digital address corresponding to the supply chain information relating to the product 50.

In alternative embodiments, the consumer device 30 may access the product's 50 supply chain information via a mobile application, a web application, or by manually entering a digital address into a digital address bar.

The user of the consumer device 30 may seamlessly, effortlessly, user-friendly, and transparently receive full knowledge of a product's 50 supply chain information. Information being possible to view in the consumer interface 32 includes the complete supply chain journey of the product 50, from commodity to the finished product. The different views provided by the consumer interface 32 will be explained further later on with reference to FIGS. 3a-c.

The distributed ledger 10 is configured to manage supply chain information of one or more products 50.

In a preferred embodiment of the invention, the distributed ledger 10 is implemented as a public blockchain. The distributed ledger 10 may in alternative embodiments be implemented publically, privately, or in a hybrid configuration, using any known distributed ledger technology (DLT), such as Hashgraph, Tangle, or Holochain. In the preferred embodiment implementing public blockchains, the distributed ledger 10 is configured to manage the supply chain information in a continuously growing list of transaction data records related to the system 100. The transactions are chained in blocks being cryptographically secured from tampering and revision, using suitable hash functions such as SHA-256, thereby making the distributed ledger 10 immutable. Changes in the distributed ledger 10 as referred to hereinafter in this disclosure is thus referring to the continuous growing list of transaction data records. For supply management information to be changed in the distributed ledger 10, all users participating in the chain needs to meet a mutual agreement, or consensus. When consensus is met, the distributed ledger 10 may be configured to cause changes to itself, or update itself, in response to several different signals. The distributed ledger 10 will be described more in detail with reference to FIG. 3a-q.

The system 100 shown in FIGS. 1 and 2 further comprises a processing unit 20. The processing unit 20 is preferably based on cloud-computing technologies and included in a distributed cloud network widely and publicly available, or limited to, an enterprise cloud. For instance, cloud-computing technologies include, but are not limited to Amazon AWS EC2, Google App Engine, IBM Cloud, Microsoft Azure Cloud, Firebase or Apple iCloud.

In one embodiment of the invention, the computer-implemented system 100 is configured to provide a peer-to-peer wireless communication network, wherein the distributed ledger 10 provides a universal data set trusted by every participant in the network. Such universal data set is a consensus of replicated, shared, and synchronized digital data geographically spread across multiple sites, countries or institutions having no centralized administrator. The communication network together with any suitable consensus algorithm, such as Byzantine fault tolerance (PBFT), proof-of-stake (PoS) or delegated proof-of-stake (DPoS), is configured to ensure replication across nodes of the distributed ledger 10. Hence, supply chain information of one or more products 50 may be shared and be publicly viewed across the entire network. As previously mentioned, the distributed ledger 10 is configured to provide a universal state layer for every participant to trust, even if they have never digitally met before. This is particularly useful in the disclosed invention, since the computer-implemented system 100 relies on having complete transparency between all users being part of or related to the system 100.

Communication occurring within the peer-to-peer wireless communication network may be realized in any known short-range or long-range wireless communication techniques. Short-range techniques may involve short-range wireless RF standards based on IEEE 802.11, IEEE 802.15, ZigBee, WirelessHART, WiFi, Bluetooth®, BLE, RFID, WLAN, mesh communication, or any other form of proximity-based device-to-device radio communication signal such as LTE Direct. Short-range techniques may also include, but not be limited to a beacon protocol such as iBeacon, AltBeacon, URIBeacon or Eddystone. Long-range techniques may involve W-CDMA/HSPA, GSM, UTRAN, LTE and OFDM to name a few.

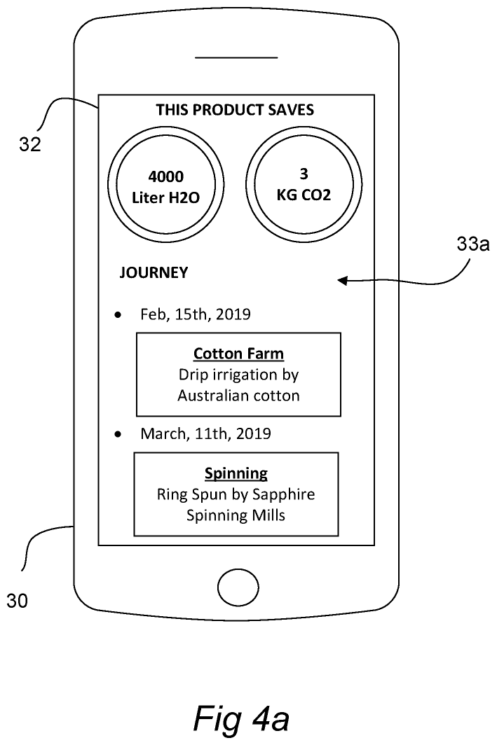

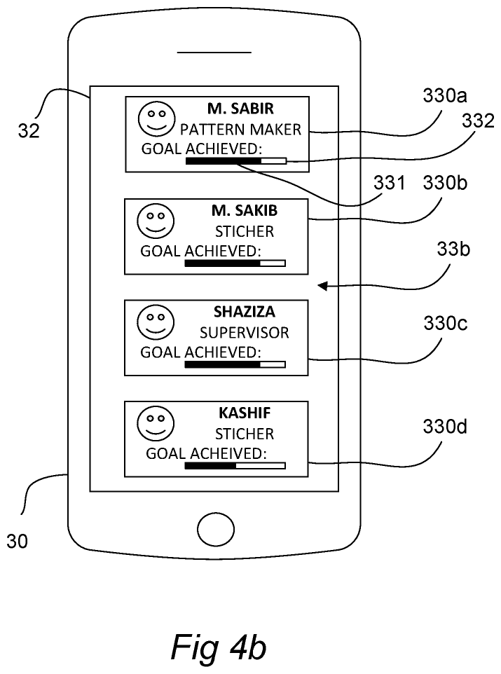

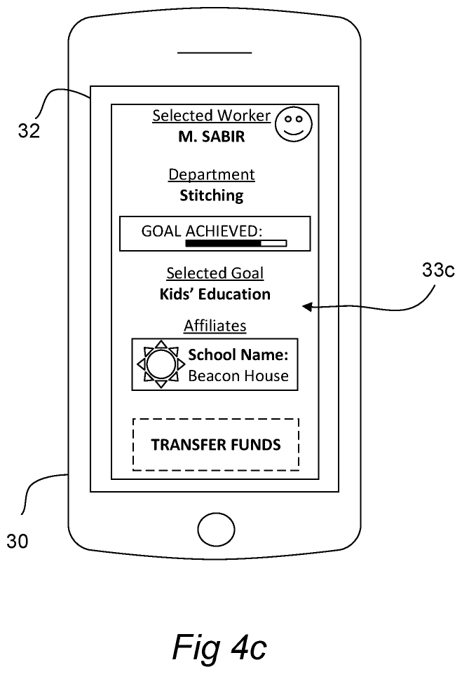

The computer-implemented system 100 shown in the embodiment of FIGS. 1 and 2 further comprises at least one consumer device 30 and at least one supplier device 40. The system 100 is scalable to be able to manage an arbitrary number of devices 30, 40. A consumer device 30 and/or a supplier device 40 may be a smart mobile communication device, such as a mobile phone, tablet computer, personal digital assistant, smart glasses, smart watch, smart bracelet, or any combination thereof. Each consumer device 30 and each supplier device 40 may comprise a consumer and a supplier interface 32, 42 (as shown in FIGS. 3 and 4), respectively, being configured to visualize supply chain information relating to the one or more products 50.

Components as presented in FIGS. 1 and 2 related to the computer-implemented system 100 may comprise and implement one or more communication interfaces based on known standards. These interfaces are configured for transceiving information between the distributed ledger 10, the processing unit 20, the at least one consumer device 30, and the at least one supplier device 40.

The consumer device 30 is configured to receive one or more consumer actions 34 through the consumer interface. The consumer actions 34 are indicative of changes to the distributed ledger 10. Different consumer actions 34 will be discussed later on with references to FIG. 3a-q. The distributed ledger 10 shown in FIG. 2 is configured to receive consumer actions 34 which is indicative of a change to itself, and will in response thereto cause changes to itself by updating its blockchain. The processing unit 20 shown in the figure will monitor the supply chain 54 of the shirt, and thereby retrieves supply chain information from the distributed ledger 10 when the consumer action 34 is recorded. The processing unit 20 may in a next step be configured to process the retrieved supply chain information by e.g. verifying the data legitimacy of the supply chain 54 of the shirt.

The supplier device 40 may be configured to receive one or more supplier actions 44 through the supplier interface 42 being indicative of changes to the distributed ledger 10. Different supplier actions 44 will be discussed later on with references to FIG. 3a-q.

FIG. 3a shows a top-down flowchart illustrating the flow of data and the associated feedback actions according to one embodiment. The embodiment comprises a user that is instructing a supplier device 40 with supplier actions 44, and a user that is instructing a consumer device 30 with consumer actions 34. The computer-implemented system 100 as shown in the image also comprises a processing unit 20 and a distributed ledger 10, and all communications occurring therewithin are shown.

In one embodiment, the distributed ledger 10 is configured to cause changes to itself in response to receiving actions 34, 44 being indicative of changes to the distributed ledger 10. Such actions 34, 44 may be received from users in the network having made transactions or actions of different types.

In one embodiment, the distributed ledger 10 is configured to cause changes to itself in response to receiving indications that one or more products have been transported 51 (as shown in FIG. 3a). Such changes may, for instance, be received from any entity in a supply chain of a product 50 responsible for transportation of products 50. Such entities may include, but is not limited to: users of the system, shipping companies, logistics, product or manufacturing facilities, brand or product companies, or stores.

In one embodiment, the distributed ledger 10 is configured to cause changes to itself in response to a predetermined time period tp having passed. Such changes may in certain situations be necessary to assure real-time synchronization of transactional records in the distributed ledger 10.

The processing unit 20 shown in FIG. 3a is configured to retrieve supply chain information from the distributed ledger 10 by monitoring a supply chain 54 of a particular product 50a among the one or more products 50. Retrieval of supply chain information may be realized by implementing any known cloud-to-blockchain information acquisition technology.

Whenever a change occurs in the distributed ledger 10 of the supply chain 54 of the particular product 50a, the processing unit 20 is configured to calculate an environmental footprint of the particular product 50a. An environmental footprint may guide consumers for taking conscious decisions to buy a product based on its ordinal value, in terms of emissions and natural resource consumptions. As the processing unit 20 continuously monitors the distributed ledger 10 for changes in the supply chain, each and every step of the journey of the product 50 may be recorded. The journey of a particular product 50a may be recorded from its first natural resource, such as a tree, to fibers, yarn, cloth, and garment. Furthermore, every tool, machine and/or manufacturing process used along the way to a finished product is monitored. Hence, every single garment supplier or worker who made any form of operation on the garment in the consumer's hands are known.

The processing unit 20 is in a preferred embodiment configured to accumulate a total environmental footprint of the particular product 50a. The processing unit 20 may in other embodiments be configured to calculate environmental footprints of a collection of products in different categories. For instance, one or more products 50 relating to one particular company or brand may be calculated. Alternatively, an environmental footprint for a specific type of product category, such as shoes, may be calculated. Yet alternatively, the processing unit 10 may calculate environmental footprint of products bought by different consumers. Even yet alternatively, average threshold values of products' 50 environmental footprint over a certain time period may be calculated. The skilled person may realize even more alternative calculations, whereby the overall goal of the environmental footprint calculation is to provide a fully transparent product view in terms of emissions and natural resource consumption. The environmental footprint calculation is made possible thanks to the transparency as provided by the distributed ledger 10.

The processing unit 20 may further be configured to process the retrieved supply chain information by verifying data legitimacy of the supply chain 54 of a particular product 50a. This involves verifying that the workers, suppliers or manufacturers behind the product 50a have not been exploited. Additionally, it verifies that no child labor is occurring. The verification process is made possible thanks to the transparency of the distributed ledger 10.

The processing unit 20 may further be configured to calculate and verify sustainability efforts of e.g. companies and/or brands according to certain standards are met. This is related to accumulating environmental footprints of a particular company and/or brand that are producing products 50 and using the computer-implemented system 100 of the disclosed invention. Consumers purchasing one or more products 50 may thus receive full knowledge in companies' environmental awareness and evaluate and rewards the sustainable practices of a company and/or brand. The distributed ledger 10 assists in both the verification of the data legitimacy of the supply chain 54 and the sustainability efforts of brands and/or companies, thanks to its transparency.

Following FIG. 3a, the first event in the flow of data is the supplier device 40 being configured to receive supplier actions 44 through the supplier interface 42 from a worker. The one or more supplier actions 44 are indicative of changes to the distributed ledger 10. An arbitrary number of supplier actions 44 are provided, although only one is illustrated in the image. In one embodiment, a supplier action 44 represents a gathering 44a of materials relating to the one or more products 50 (not shown). The user of the supplier device 40 may for instance record exactly what type of materials and the quantity of the materials that are being used to sew a garment, e.g. yarn, thread, cloth fiber, and so forth. In another embodiment, a supplier action 44 represents a processing 44b of materials relating to the one or more products 50. Such processing may involve e.g. spinning process and/or drip irrigation process, and the user of the supplier device 40 may record this as well. In yet another embodiment, a supplier action 44 represents a finished production 44c of one or more products 50. For instance, the user of the supplier device 40 records how the production was accomplished, what tools were used, how long time it took, if the product was transported between locations to finish, etc. All of the supplier actions 44a-c may be logged and timestamped. In response to the supplier device 40 having received the one or more supplier actions 44, the actions 44 are transmitted to the distributed ledger 10 for consensus confirmation of the data nodes therein.

In case of a successful information acquisition by the distributed ledger 10, the ledger 10 is configured to manage the supply chain information comprised in the supplier actions 44 by causing changes to itself In the image, this is indicated as the returning arrow of the distributed ledger 10. The processing unit 20 is configured to continuously monitor a supply chain 54 of a particular product 50a (not shown) among the one or more products 50. In the figure, this is indicated as the arrow from the processing unit 20 to the distributed ledger 10. Hence, supply chain information can be retrieved by the processing unit 20 for further processing. As has been discussed before, every change in the distributed ledger 10 may be processed by calculating an environmental footprint of the particular product 50a. In the embodiment shown, the four following steps are indicating that the one or more produced products 50 are being transported 51 from the supplier, to an intermittent location such as a distribution center, and finally to a store. The distributed ledger 10 is in these steps configured to cause changes to itself corresponding in response to the products 50 being transported, and the processing unit 20 monitors these steps as well. Based on the supply chain information retrieved thus far by the processing unit 20, the processing unit 20 may be configured to accumulate a total environmental footprint of the particular product 50, as previously described. The processing unit 20 may further verify data legitimacy of the supply chain, as well as calculating and verifying the sustainability efforts of the companies or brands behind the one or more products 50.

The next step in the flowchart indicates that the consumer device 30 is configured to receive consumer actions 34 through the consumer interface 32 from a consumer. The one or more consumer actions 34 are indicative of changes to the distributed ledger 10. An arbitrary number of consumer actions 34 are provided, although only one two actions 34 are illustrated in the image. In one embodiment, a consumer action 34 represents a purchase 34a of a product 50. Although not necessary, this purchase is typically performed in a store after the readable tag 52 (not shown) associated with the product 50 has been scanned by the consumer device 30 and a suitable selection has been made through the consumer interface 32 of the consumer device 30. In other embodiments, the consumer device 30 does not necessarily scan the readable tag 52, as e.g. a store clerk may instead comprise a device capable of scanning the tag 52 when the product 50 has been bought. In another embodiment, a consumer action 34 is representing an environmental compensation 34b of a product. The environmental compensation can be seen as a return system for the nature to heal. For instance, if a tree has been chopped down to produce a shirt, the consumer may choose to view the supply chain of the shirt and environmentally compensate by donating funds for planting of new trees. This process may be done seamlessly through the consumer interface 32 of the consumer device 30 with e.g. a simple click. The instantaneous feedback given by scanning the readable tag 52 associated with a product 50 will provide enough information for the consumer to make a conscious and environmentally friendly decision, based on e.g. the environmental footprint. In other embodiments, the user of the consumer device 30 may compensate a product 50, thereby automatically authorizing the funds associated with the product 50. Since the distributed ledger 10 assures secure transactions and transparency, the consumer can be absolutely certain an actual tree is planted in response to sufficient funds being donated. In yet another embodiment, a consumer action 34 represents a support 34c to social causes. Similar to the environmental compensation, the consumer may, through the consumer interface 32 of the consumer device 30, receive sufficient supply chain information by scanning the readable tag 52 to be able to make a conscious decision. The consumer may e.g. choose to support manufacturer or workers in third-world countries wherein the actual products being purchased are produced. Similar as for the supplier actions 44, all of the consumer actions 34a-c are logged and timestamped. In response to the consumer device 30 having received the one or more consumer actions 34, the actions 34 are transmitted to the distributed ledger 10 for consensus confirmation of the data nodes therein.

In case of a successful information acquisition by the distributed ledger 10, the ledger 10 is configured to manage the supply chain information comprised in the consumer actions 34 by causing changes to itself. As were the case with the supplier actions 44, this step is indicated by the returning arrows associated with the distributed ledger 10. The processing unit 20 is also configured to continuously monitor the supply chain 54 of the particular product 50a being scanned by the consumer device 30 among the one or more products. Hence, supply chain information can be retrieved by the processing unit 20 for further processing.

The embodiment shown also involves a step of a consumer action 34 representing a donation 34d of a gift to a worker. A donation 34d of a gift may be in the form of education hours or monetary funds. Similar to the other consumer actions 34, the distributed ledger 10 is configured to update itself in response to receiving a donation 34d of a gift. Moreover, the distributed ledger 10 is further configured to update itself in response to receiving a request of retrieval 44c of a donation from a supplier device 40. The processing unit 20 is further configured to retrieve and process the associated supply chain information. As shown in the image, the distributed ledger 10 is further configured to cause changes to itself in response to a predetermined time period tp having passed. This is preferably done when data synchronization is desired or required.

In any step of the flowchart as explained with reference to FIG. 3a, feedback in form of e.g. notifications, pop-ups, messages, and so on, may be given from the processing unit 20 to the supplier and/or consumer device 30, 40 whenever a confirmation of the actions 34, 44 is appropriate.

An embodiment of data flows in the computer-implemented system 100 has been described with reference to FIG. 3a. The system 100 is however not restricted to a data flow exactly like the one explained with the image. Different system 100 configurations may be realized in terms of the number of supplier devices 40, the number of consumer devices 30 and how many actions 34, 44 the respective device 30, 40 receives. The system 100 is however in all cases configured to be synchronized in at least near real time, and ideally with as low latency as possible. Near-real time synchronization may preferably be provisioned by the distributed ledger 10 causing changes to itself in response to a predetermined time period tp having passed.

With reference to FIG. 3b, another illustration of a flowchart according to one embodiment is shown. Herein, the human entities (people, organizations, etc.) are illustrated in rectangular shapes, and the process steps 1000-1140 (materials, products, data) are illustrated in circular shapes. Some of the human entities are associated with the supplier devices 40 and some are associated with the consumer devices 30. Similarly, some of the process steps are associated with the supplier and/or consumer actions 33, 43, or the distributed ledger 10 updates. The entire flowchart as illustrated is preferably implemented by the computer-implemented system 100, and orchestrated by the distributed ledger 10 for verifiable transactions. The processing unit 20 may be configured to handle data legitimacy verification and/or verification of brands' environmental efforts along the steps. In the image, the dashed arrows are indicative of changes to the distributed ledger 10. The lined arrows, on the other hand, indicate a new process step. The steps and/or entities presented is just an example of how the flow of data may be conducted in the system 100. In other embodiments, some steps or entities may be omitted or added, shall the system 100 receive other actions 33, 43 from supplier or consumer devices 30, 40 or other entities.

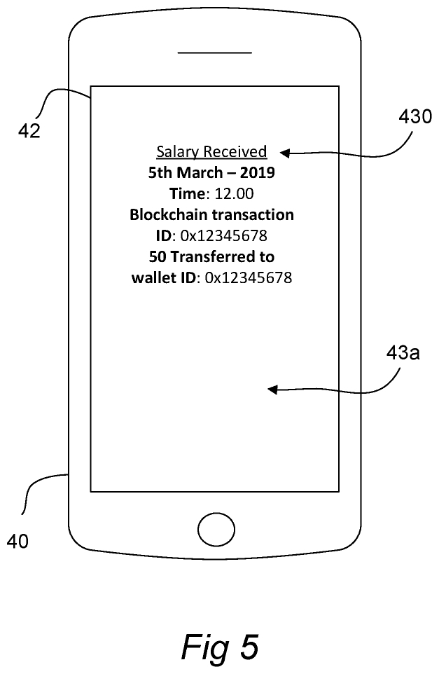

Following the circular shapes, top down, a first step 1000 involves brand ordering of a product 50. In response thereto, notifications are given to factory devices associated with the system 100. A set of steps 1010, 1020, 1030, 1050 of gathering, processing and transporting materials, and producing a product 50 are hence initiated. A factory, a supplier and a shipper is typically responsible for carrying out these steps. The distributed ledger 10 may update itself in response to obtaining the associated supplier and distributed ledger actions 43, 51 from the supplier device 30 and the distributed ledger 10. Another step 1040 of providing a third party forensics lab may be included. The forensics lab may incorporate physical testing of the materials at any stage of the supply chain as illustrated in FIG. 5. This process may for instance be conducted by a, by the distributed ledger 10, verified third party. As an example, the third party forensics module may test the materials before the worker is e.g. sewing a piece of clothing together.

FIG. 3b also involves two steps 1060, 1070 of providing a payroll and verification process for the worker(s) associated in producing the product 50.

Following FIG. 3b, additional steps 1080, 1090 of transporting 51 the product 50 between different entities in the supply chain are provided, and updates to the distributed ledger 10 are hence occurring. These steps include involvement with different entities in the supply chain, such as factories, suppliers and/or brands. The flowchart shown also involves a step 1100 of affiliate engagement.

Additionally, the process shown in FIG. 3b involves the steps of product purchase 1100, environmental compensation 1120, tree plantation 1130 and gift donation 1140. These steps are occurring in response to a consumer device 30 performing consumer actions 33. As shown in the illustration, retail stores, affiliates, schools and guardians are involved in collecting data or funds in response to some of these steps occurring.

FIGS. 3c-q illustrate, in detail, different embodiments of how a computer-implemented system 100 may implement the different process steps 1000-1140 as described in relation to FIG. 3b. The illustrations shown may in alternative embodiments be implemented with fewer and/or additional steps associated with the process step. In the following examples, the distributed ledger 10 has been implemented as a blockchain 10.

FIG. 3c is an illustrative example of how the computer-implemented system may implement the step of brand order acceptance 1000.

FIG. 3d is an illustrative example of how the computer-implemented system 100 may implement the step of material gathering (procurement) 1010.

FIG. 3e is an illustrative example of how the computer-implemented system 100 may implement the step of material processing 1020.

FIG. 3f is an illustrative example of how the computer-implemented system 100 may implement the step of material transport (shipping) 1030.

FIG. 3g is an illustrative example of how the computer-implemented system 100 may implement the step of material verification 1040.

FIG. 3h is an illustrative example of how the computer-implemented system 100 may implement the step of production 1050.

FIG. 3i is an illustrative example of how the computer-implemented system 100 may implement the step of payroll process 1060.

FIG. 3j is an illustrative example of how the computer-implemented system 100 may implement the step of payroll verification (for workers) 1070.

FIG. 3k is an illustrative example of how the computer-implemented system 100 may implement the step of product transport (shipping) 1080.

FIG. 3l is an illustrative example of how the computer-implemented system 100 may implement the step of product transport (distribution) 1090.

FIG. 3m is an illustrative example of how the computer-implemented system 100 may implement the step of affiliate engagement 1100.

FIG. 3n is an illustrative example of how the computer-implemented system 100 may implement the step of product purchase (sale) 1110.

FIG. 3o is an illustrative example of how the computer-implemented system 100 may implement the step of environmental compensation (compensation) 1120.

FIG. 3p is an illustrative example of how the computer-implemented system 100 may implement the step of tree plantation (plantation) 1130.

FIG. 3q is an illustrative example of how the computer-implemented system 100 may implement the step of gift donation (education) 1140.

FIGS. 4a-c and FIG. 5 illustrate different views 33, 43 presented by the consumer interface 32 of the consumer device 30 or the supplier interface 42 of the supplier device 40. The skilled person knows that different types of similar supply chain information not disclosed in FIGS. 4a-c and FIG. 5 may serve as other interface 32, 42 configurations. The views 33, 43 shown for the consumer device 30 may in some embodiments also be shown for the supplier device 40, and vice versa.

FIG. 4a is a product view 33a shown in response to the consumer device 30 having received information of a product, for example by having scanned a readable tag 52 associated with a product 50 or by entering a code or the like. The image shown is just an example of what type of information may be provided for a user of a consumer device 30. As can be seen in FIG. 4a, supply chain information relating to the product 50 include, for instance, how many liters of water is saved thanks to e.g. a sustainable manufacturing and/or transporting process. It furthermore includes information relating to carbon dioxide emission reductions. The information shown in the product view 33a is continuously being updated. Hence, the actual numbers shown are just a snapshot of the actual impact for one point in time. As these numbers continuously updates itself powered by the distributed ledger 10, the product view 33a may show different numbers at any point later on in time. The consumer interface 32 may further be configured to illustrate data legitimacy of the supply chain information of the product 50 associated with the tag 52 being read. Such data legitimacy check may for instance be illustrated as a “VERIFIED”-sign, or similarly, indicating that the data presented is verified in the distributed ledger 10. Additionally, or alternatively, sustainability efforts of the companies or brands behind the one or more products 50 may be shown. A similar “VERIFIED”-sign as were the case of data legitimacy, or an exhaustive list of environmental goals may be shown. The complete journey of the product 50 may be visualized, showing e.g. dates, geographical locations, manufacturing methods, resource choices, which workers at which steps are associated with the specific product 50, and so forth.

In FIG. 4b, the user of the consumer device 30 has selected a different view 33 of the consumer interface 32. The consumer interface 32 is in this image configured to visualize a worker view 33b. The worker view 33b is a list of workers 330a-d associated with producing the product 50. Each worker 330a-d of the worker view 33b may include a marker 331 of how close they are until their personal goal 332 has been achieved, in terms of raising funds for e.g. personal objects. These profiles shown in the worker view may be created by the worker itself using a supplier device 40.

FIG. 4c shows another embodiment of a view presented by the consumer interface 32. The view shown is a specific worker view 33c, wherein the user of the consumer device 30 has selected a specific worker from the worker view 33b. Hence, more detailed information about each worker's profile can be seen, relating to e.g. salaries, minimum wages, goals, affiliates, geographical location, manufacturing facility details, and so forth. The consumer device 30 may in this view also be configured to transfer funds (e.g. donate a gift) to the selected worker, if the user of the device 30 is of the opinion that the particular piece of clothing is exceptionally well crafted or if the worker for other reasons deserves a donation. Donations may be directly transferred from a user or a brand to a school or worker, and verified in the distributed ledger 10. In the embodiment of a school donation, the school is in response to receiving funds enrolling kids and the kids' guardians verify the process through the distributed ledger 10.

FIG. 5 illustrates an exemplary embodiment of a supplier device 40 having a supplier interface 42 being configured to visualize supply chain information. The view shown in the example is a salaries view 43a, wherein salary details 430 are presented. The salaries view 43a is however by no means limited to only showing such information, as other reasonable information relating to the supply chain may be visualized. Salary details 430 shown in this particular example includes date, time, blockchain transaction ID and wallet transaction ID.

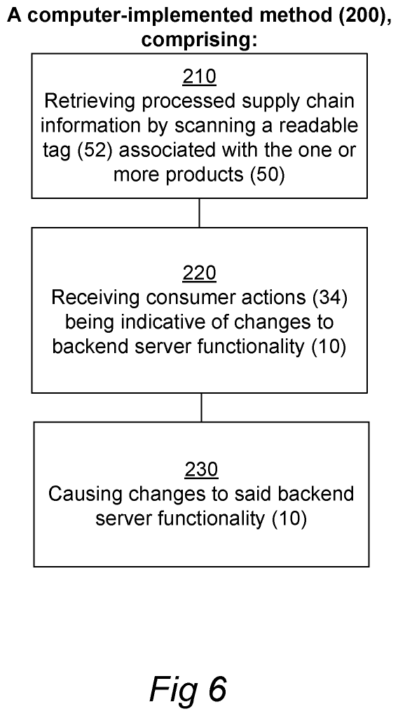

With reference to FIG. 6, an embodiment of a computer-implemented method 200 is shown. The method 200 is based on operating a consumer device 30 to allow its user to provide supply chain information relating to one or more products 50. Hence, the method 200 can be viewed as steps taken in a “frontend” perspective by a user of the consumer device 30. Such user is typically a normal consumer browsing products in e.g. a store. Alternatively, the user may be browsing an online website comprising the one or more products. In other embodiments, the consumer device 30 is operated by a company representative of some sort.

The method 200 comprises a step of retrieving 210 processed supply chain information by scanning a readable tag 52 associated with the one or more products 50. The supply chain information has been processed by backend server functionality 10, 20, such as a distributed ledger 10 (not shown) or a processing unit 20 (not shown), and the retrieved information is obtained in a human-readable form. Hence, the retrieving step 210 causes visualization in a consumer interface 32 of the consumer device 30, for the user to create an opinion about product 50 associated with the tag 52. The tag 52 is typically scanned in a physical store, commerce markets, or outlets, but it may also be scanned at a monitor on e.g. websites for e-commerce purposes, commercial banners, informative posters, or wherever appropriate.

The method 200 further comprises a step of receiving 220 consumer actions 34 being indicative of changes to backend server functionality 10. The backend server functionality is in this case a distributed ledger 10 being implemented according to any of the techniques described in this disclosure. Consumer actions 34 are representing any of the previously mentioned alternatives, and may also be some other type of action 34 realized by the person skilled in the arts. The actions 34 are provided in response to a user of the consumer device 30 interacting with an interface of the device 30, such as a consumer interface 32. The consumer interface 32 may be a graphical user interface, such as a mobile screen. Alternatively, the consumer device 30 may receive consumer actions 34 using techniques such as e.g. speech-to-text communication, haptic communication, visual cues, or other similar technology.

The method 200 also comprises a step of causing changes to said backend server functionality 10. This step is preferably caused in direct response to the consumer device 30 having received consumer actions 34, and causing changes corresponds to information being transmitted from the consumer device 30 to the distributed ledger 10.

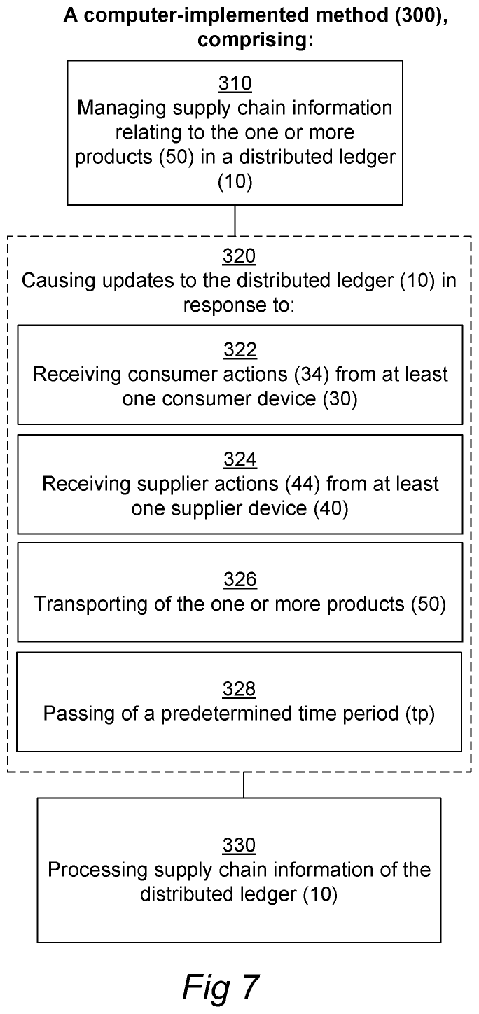

With reference to FIG. 7, an embodiment of a computer-implemented method 300 is shown. The method 300 is based on providing supply chain information relating to one or more products 50. Hence, the method 300 can be viewed as steps taken in a “backend” perspective by backend server functionality, such as e.g. a distributed ledger 10 and a processing unit 20 (not shown).

The method 300 comprises a step of managing supply chain information relating to the one or more products in a distributed ledger 10. The supply chain information is managed according to techniques as previously disclosed, i.e. public blockchain technology, or similar distributed ledger 10 implementations.

The method 300 further comprises a step of causing updates to the distributed ledger 10 in response to one or more of the following steps which will now be described according to different embodiments.

In one embodiment, updates are caused in response to receiving 322 from at least one consumer device 30. Data from the consumer device 30 is received from the user operating the device 30 according to the “frontend” perspective as just described.

In a similar procedure, the distributed ledger 10 is in another embodiment causing updates to itself in response to receiving 324 supplier actions 44 from at least one supplier device 30. The supplier device 30 is typically operated by e.g. a worker or manufacturer that is producing the one or more products 50. The user behind the supplier device 30 is, from their perspective, operating a supplier device 40 from a “frontend” perspective. The supplier actions 44 are related to one or more of the actions 44 as previously described, or any suitable action possibly being taken by a user of the supplier device 40.

In another embodiment, the distributed ledger 10 is causing updates to itself in response to the one or more products 50 being transported 326. This step is preferred in the cases where no supplier and consumer device 30, 40 are in the vicinity of the product 50 and supply chain information changes occur. For instance, a distribution center being intermittently responsible for handling transport of products 50 between manufacturers and stores. In these cases, an auxiliary device may be configured to cause changes to the distributed ledger 10. Such an auxiliary device may be configured similarly as the consumer or supplier device 30, 40, and it may be incorporated in the computer-implemented system 100 in a similar fashion. The auxiliary device may receive auxiliary actions representing e.g. environmental impact of transporting, storing or handling the incoming or outgoing products 50.

In yet another embodiment, the distributed ledger 10 is causing updates to itself in response to passing of a predetermined time period tp. This may be useful when a real-time or at least near real-time synchronization of the ledger 10 is desired. The predetermined time period tp is preferably determined according to stored computer instructions configured to be executed by modules internal to the system 100.

The method 300 further comprises a step of processing 330 supply chain information of the distributed ledger 10. This step 330 is preferably carried out by a processing unit 20 according to techniques as previously disclosed.

In the following a few examples of embodiments will be given. As shown in FIGS. 4a-c, a view from a customer app that enables the customer to pay the worker that produced the item an extra salary, in the form of a tip or donation. The customer may choose between different values. FIG. 5 further shows a view of an exemplary embodiment of an interface of a worker app. The worker app may be used by the worker to provide information that can be seen in the customer app. Information that can be added relates to name, age, education, family status, where he/she is employed, how long the employment has lasted, the city which the employment is located and so on. The worker may also add which goals he/she wishes to achieve. This could for example be the wish to provide money so that children may go to school. The worker may also add payment information. The worker app also enables the worker to keep track of where the item he/she has produced is sold and used. The customer app may show all relevant details of the worker, such as name, age, education, family status, where he/she is employed, how long the employment has lasted, the city which the employment is located and so on. The interface for the customer app may also show that the salary is paid lawfully, and possibly that he/she is paying the prescribed taxes and so on. In the interface for the customer it may also be possible to help the worker to achieve his/her life goals. This can be achieved by graphical objects, such as buttons, in the interface that that allows for different donations and/or tipping.

With references to FIG. 4a, an embodiment of a consumer application interface is shown. Here one can see the journey that the item has had during production. It may state what type of production that took place, and where and when it happened. For example, it may start on a cotton farm in Australia, then spinning is performed in Pakistan and then a knitting step is performed before transmitting the item to a warehouse. The calculator calculates the emissions and effects on the environment and shows how much the item has “cost” in environmental terms and/or how much it has saved using this production line.

The tag is preferably readable using techniques such as e.g. NFC or RFID, and attached to the product. The tag may be scanned using a handheld device, such as a mobile phone or similar. The fabric applies a scannable tag or similar identification means to the item, that may be a garment (such as a sweater, pants, jacket, etc.). The user, or the store chain, may scan the identification means using a handheld device. The handheld device may be a mobile phone, or other communication device being capable of scanning or otherwise identifying the identification means. The handheld device should preferably have a display to show the interface of the application (app). The customer or store personnel scans the identification means and will thus receive information about the item, such as a garment. The information can be shared using different applications that cooperates with each other.

The digital platform is a place for brands to find sustainable suppliers and use sustainable materials in their design process. It is a marketplace but only a closed group of sustainable and fashion brand backed suppliers will be available on this marketplace. The digital platform will also be able to provide brands a traceability of afterlife of a garment. This will be offered by mutual consent of the consumer. The customers can switch on an off the tracking of garment. The tracking will only occur when the consumer scans the code. The digital platform should be able to provide the solution for discarding the garment and putting it back to the supply chain.

The digital platform may comprise a so-called environmental calculator which automatically calculates the footprint of that particular product. Consumers can take conscious decisions to buy a product based on its ordinal value. The environmental calculator, monitors the journey of the product and calculates each steps actual environmental footprint.

The digital platform will show you every single garment worker who made any form of operation on the piece of clothing in your hands. The workers are voluntarily setting up their profiles with some basic information and if you are satisfied with the craftsmanship, there is a function to send a tip to any or all of the workers involved in the creation of the garment. Any such gift is fully traceable in the blockchain and in a matter of minutes, you can verify that the transaction took place and was received by the intended person/s.

The digital platform may further comprise a crowdfunding platform, which allows contributions towards either education for the children of the workers, or skill enhancement programs that would increase the earning capacity of the worker as well as climbing the professional ladder. The consumer using the crowdfunding platform will only be charged by the school once the person is enrolled and once the identities of the worker or their kids have been confirmed. Additionally, there is an option to see the transaction history of the school and be confident that even a small support is actually creating a big impact. The contribution to the school contribution is transparent and traceable with the power of Blockchain.

The digital platform may further comprise a donation's module. This module allows you to filter out the workers from the network of factories and either send a direct donation or donate for quality education for them or their kids, and all is transparent and traceable.

In one embodiment the product is a garment. More specifically, the garment is a textile garment. In the following example the garment is a sweatshirt and illustrates the line of process from developing the product, the customer buying the product and the feedback given to the customer. In this example, the customer will buy a product. The product may for example be bought online. The transaction may be registered through an app or website. This will give them some discount which can be used either as a financial gift or they can save it for the future because it will increase in value due to ICO (Internal coin offering). The consumers will also be able to buy more coins from the fashion brand company using the increased value of the coins. Once the consumers have received the garment, the consumers will be able to scan a logo on garment and see the people behind that product. They will be able to pay for a gift and contribute to a social cause.

Nov turning to an example of how the production process may look like. The product may be made by for example cotton or bamboo. The materials are being ordered through smart contracts within the blockchain (or system) platform, meaning that all orders are being made, confirmed, as well as paid through the blockchain (or system). Once the cotton arrives, it's first processed to yarn, then fabric and afterwards the fabric is being dyed. The journey of the material as well as the development of the product until it arrives in the sewing factory, is also being processed through the blockchain with smart contracts. Once the completed fabrics arrives in the garment factory, the first operation is to stitch a tag onto the garment. From that moment, all the processes of production are being logged continuously for that particular piece of clothing, giving the exact data for each and every garment in the factory. This infrastructure is also a security and a great working tool for the workers, as they are able to see exactly all their work being logged per garment as well as for the total number of clothing. The workers can at any point in time see exactly all their work done. Before any piece of clothing is leaving the factory, the following three points has to be fulfilled; the salaries for the workers on each garment has been paid as per law, all he workers on each garment has an employment contract, and all the workers have received their salary slip.

In one embodiment the system is used with a crypto-currency. The crypto-currency is the ethical currency involved in trading within supply chain of consumers, brands and suppliers of the fashion brand as well as general public at a later stage. The people who buy the crypto currency will be owning the fashion brand company. It's like shares of the company with a real intrinsic value of fashion brand company. However, as should be understood by a person skilled in the art, other types of currencies can be used with the present invention. Crypto-currencies may use Proof-of-Work (PoW) or Proof-of-Stake (PoS) concepts.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1-21. (canceled)

22. A computer-implemented system for providing supply chain information of one or more products, wherein the system comprises:
a distributed ledger configured to manage supply chain information of the one or more products;
a processing unit configured to retrieve said supply chain information from the distributed ledger by monitoring a supply chain of a particular product among the one or more products, and process said retrieved supply chain information; and
at least one consumer device configured to retrieve said processed supply chain information and to cause at least one change to the distributed ledger,
wherein, for every change in the distributed ledger of the supply chain of the particular product, the processing unit is further configured to calculate an environmental footprint of the particular product, and accumulate a total environmental footprint of the particular product, and
wherein the processing unit is further configured to process said retrieved supply chain information by verifying data legitimacy of the supply chain of the particular product and calculate and verify sustainability efforts of the companies or brands behind the particular product.

23. The system according to claim 22, wherein the at least one consumer device is configured to retrieve said processed supply chain information by scanning a readable tag associated with the one or more products.

24. The system according to claim 22, wherein the at least one consumer device comprises a consumer interface configured to visualize supply chain information relating to the one or more products.

25. The system according to claim 24, wherein the consumer interface is further configured to visualize:
data legitimacy of the supply chain information of the one or more products, and/or sustainability efforts of the companies or brands behind the one or more products.

26. The system according to claim 24, wherein the at least one consumer device is configured to receive one or more consumer actions through the consumer interface, the one or more consumer actions being indicative of at least one change to the distributed ledger .

27. The system according to claim 26, wherein the one or more consumer actions is representing:
a purchase of a product;
an environmental compensation of a product;
a support to social causes; and/or
a donation of a gift.

28. The system according to claim 22, wherein the system further comprises at least one supplier device comprising a supplier interface configured to visualize supply chain information relating to the one or more products.

29. The system according to claim 28, wherein the at least one supplier device is configured to receive one or more supplier actions through the supplier interface, the one or more supplier actions being indicative of at least one change to the distributed ledger.

30. The system according to claim 29, wherein the one or more supplier actions is representing:
a gathering of materials relating to the one or more products;
a processing of materials relating to the one or more products;
a production of one or more products; and/or
a retrieval of a donation.

31. The system according to claim 22, wherein the distributed ledger is configured to manage supply chain information of the one or more products by causing changes to itself in response to:
receiving actions being indicative of changes to the distributed ledger;
the one or more products being transported; and/or
a predetermined time period having passed.

32. The system according to claim 22, wherein the one or more products is a garment and supply chain information thereof involves organizations, people, activities or resources involved in supplying said garment.

33. A consumer device configured to perform the functionality of the at least one consumer device as defined in claim 22.

34. A product associated with a readable tag, the readable tag being configured to be scanned by a consumer device according to claim 33.

35. A computer-implemented method for operating a consumer device to allow its user to provide supply chain information relating to a supply chain of a particular product among one or more products, wherein the method comprises:
retrieving processed supply chain information by scanning a readable tag associated with the one or more products, wherein the processed supply chain information includes an accumulated total environmental footprint of the particular product, and wherein the processed supply chain information includes sustainability efforts of the companies or brands behind the particular product;
receiving consumer actions being indicative of changes to backend server functionality; and
causing changes to said backend server functionality.

36. A computer-implemented method for providing supply chain information relating to one or more products, wherein the method comprises:
managing supply chain information relating to the one or more products in a distributed ledger;
causing changes to the distributed ledger in response to:
receiving consumer actions from at least one consumer device,
receiving supplier actions from at least one supplier device, transporting of the one or more products, or passing of a predetermined time period; and
processing supply chain information of the distributed ledger.

37. A computer program product comprising computer code for performing the method according to claim 35 when the computer program code is executed by a processing device.

38. A computer program product comprising computer code for performing the method according to claim 36 when the computer program code is executed by a processing device.
